(19) United States
(12) Patent Application Publication
(10) Pub. No.: US 2014/0092040 A1
(43) Pub. Date: Apr. 3, 2014

(54) ELECTRONIC APPARATUS AND DISPLAY CONTROL METHOD

(71) Applicant: KABUSHIKI KAISHA TOSHIBA, Tokyo (JP)

(72) Inventors: Yoji Nagao, Ome-shi (JP); Tomohiro Hanyu, Ome-shi (JP)

(73) Assignee: KABUSHIKI KAISHA TOSHIBA, Tokyo (JP)

(21) Appl. No.: 13/954,595

(22) Filed: Jul. 30, 2013

(30) Foreign Application Priority Data
Sep. 28, 2012 (JP) 2012-218136

(51) Int. Cl. G06F 3/0488

(52) U.S. Cl. CPC G06F 3/0488
USPC 345/173

(57) ABSTRACT

According to one embodiment, an electronic apparatus includes a display, a touch panel, a detector, and a controller. The touch panel is provided on the display. The detector detects motion of the electronic apparatus. The controller changes a display position of an image displayed on the display when the motion is detected.

### CROSS-REFERENCE TO RELATED APPLICATIONS

This application is based upon and claims the benefit of priority from Japanese Patent Application No. 2012-218136, filed Sep. 28, 2012, the entire contents of which are incorporated herein by reference.

### FIELD

Embodiments described herein relate generally to an electronic apparatus including a touch screen display and a display control method applied to the electronic apparatus.

### BACKGROUND

Recently, various types of electronic apparatuses such as tablets and PCs (Personal Computers) have been developed. Many electronic apparatuses of this type include a touch screen display. The user touches the screen with his/her finger and can perform various kinds of operations (to be referred to as touch operations hereinafter) in accordance with the movement of the finger touching the screen.

When, however, performing touch operation with the same hand as that holding an electronic apparatus, the user cannot sometimes touch a desired position on the touch screen display, e.g., an end portion of the screen of the touch screen display, due to limitations on the reaches of the fingers. In such a case, the user needs to perform touch operation with the other hand. This may lead to a deterioration in the operability of the electronic apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to an embodiment;

FIG. 2 is an exemplary block diagram showing the system configuration of the electronic apparatus according to this embodiment;

FIG. 3 is an exemplary block diagram showing the configuration of a screen display position control program executed by the electronic apparatus according to this embodiment;

FIG. 4 is an exemplary view showing an example of the normal display screen of the electronic apparatus according to this embodiment;

FIG. 5 is an exemplary view showing an example of the offset display screen of the electronic apparatus according to this embodiment;

FIG. 6 is an exemplary view showing another example of the normal display screen of the electronic apparatus according to this embodiment;

FIG. 7 is an exemplary view showing another example of the offset display screen of the electronic apparatus according to this embodiment;

FIG. 8 is an exemplary view showing still another example of the offset display screen of the electronic apparatus according to this embodiment;

FIG. 9 is an exemplary view showing still another example of the offset display screen of the electronic apparatus according to this embodiment;

FIG. 10 is an exemplary view showing still another example of the offset display screen of the electronic apparatus according to this embodiment;

FIG. 11 is an exemplary view showing still another example of the offset display screen of the electronic apparatus according to this embodiment;

FIG. 12 is an exemplary view showing still another example of the offset display screen of the electronic apparatus according to this embodiment;

FIG. 13 is an exemplary view showing still another example of the offset display screen of the electronic apparatus according to this embodiment;

FIG. 14 is an exemplary flowchart showing a procedure for screen display position control processing executed by the electronic apparatus according to this embodiment;

FIG. 15 is an exemplary view showing an example of input coordinate conversion based on a screen display position control program executed by the electronic apparatus according to this embodiment; and

FIG. 16 is an exemplary view showing another example of input coordinate conversion based on the screen display position control program executed by the electronic apparatus according to this embodiment.

### DETAILED DESCRIPTION

Various embodiments will be described hereinafter with reference to the accompanying drawings.

In general, according to one embodiment, an electronic apparatus includes a display, a touch panel, a detector, and a controller. The touch panel is provided on the display. The detector detects motion of the electronic apparatus. The controller changes a display position of an image displayed on the display when the motion is detected.

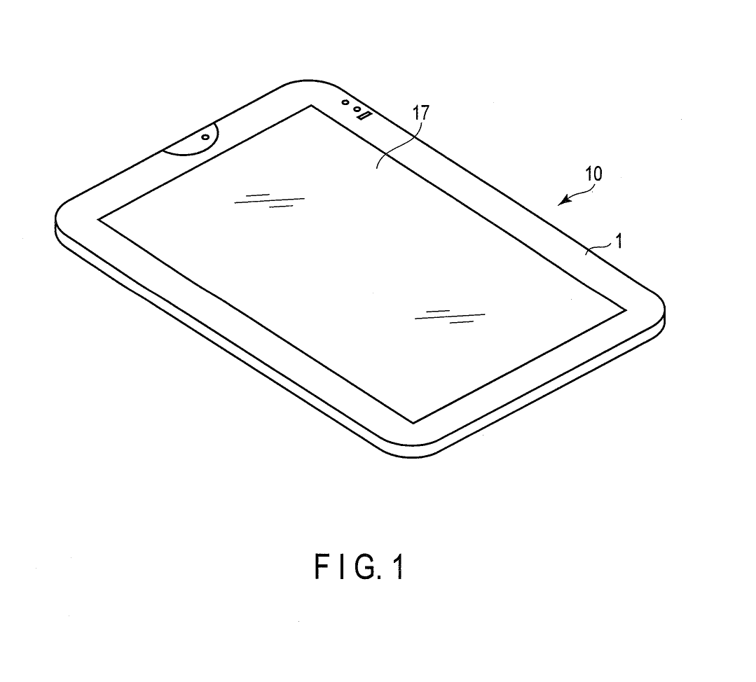

The outer appearance of the electronic apparatus according to an embodiment will be described with reference to FIG. 1. The electronic apparatus according to this embodiment is a portable electronic apparatus implemented by, for example, a tablet computer 10. This electronic apparatus may be implemented as a notebook type personal computer, smartphone, PDA, or the like.

The tablet computer 10 includes a computer main body 1 and a touch screen display 17. The computer main body 1 has a thin box like housing. The touch screen display 17 is placed on the upper surface of the computer main body 1. The touch screen display 17 includes a flat panel display (e.g., an LCD (Liquid Crystal Display)) and a touch panel. The touch panel is provided to cover the screen of the flat panel display. The touch panel is configured to detect the position on the touch screen display 17 at which the user has touched with his/her finger or a pen.

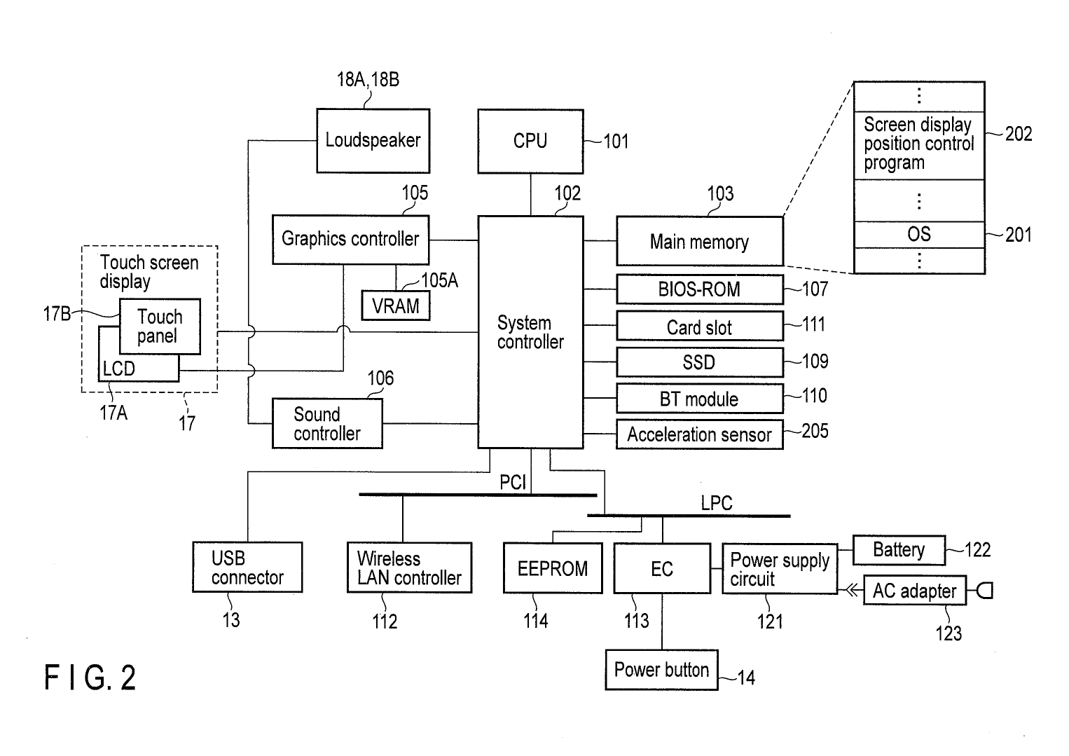

An outline of the system configuration of the electronic apparatus according to this embodiment will be described next with reference to FIG. 2.

The tablet computer 10 includes a CPU (Central Processing Unit) 101, a system controller 102, a main memory 103, a graphics controller (GPU) 105, a sound controller 106, a BIOS-ROM 107, a SSD (Solid-State Drive) 109, a BT (Bluetooth®) module 110, a card slot 111, a wireless LAN controller 112, an EC (Embedded Controller) 113, an EEPROM 114, a USB connector 13, a touch screen display 17, a video memory (VRAM) 105A, and an acceleration sensor 205.

The CPU 101 is a processor which controls the operation of each module in the tablet computer 10. The CPU 101 executes an OS (Operating System) 201 and various types of application programs which are loaded from the SSD 109 into the main memory 103. The application programs include a screen display position control program 202.

The screen display position control program 202 is a program for automatically changing the display position of display content displayed on the screen of the touch screen display 17. The display content whose display position is changed are, for example, the full screen image displayed on the screen of the touch screen display 17. In this, the screen display position control program 202 changes (shifts) the display position of an image (screen image) on the screen of the touch screen display 17 without changing the size of the image displayed on the screen. The screen display position control program 202 changes (shifts) the display position of the screen image so as to make part of the screen image run off the screen of the touch screen display 17 to be hidden (not displayed) without changing the size of the image displayed on the screen. That is the screen display position control program 202 changes (shifts) the display position of the screen image so as not to display part of the screen image on the screen without changing the size of the image displayed on the screen. This makes it possible to change the physical position, at which a specific portion to be touched by the user on the screen image is located, on the screen of the touch screen display 17. Alternatively, the display content (screen image) whose display position is to be changed may include a display object on the screen, e.g., a menu, button, or control panel. If the screen image includes a plurality of layers, the display content whose display position is to be changed may include, for example, the foreground layer.

The screen display position control program 202 can perform conversion processing for input coordinates in accordance with a change in the display position of display content. The input coordinates indicate a touch position on the touch screen display 17. Note that the screen display position control program 202 may be a program included in the OS 201.

Note that the screen display position control program 202 may change only the display position of a display object on the screen instead of changing the display position of the overall screen image. In this case, the screen display position control program 202 changes, for example, the display position of a layer including a display object whose display position is to be changed, and performs coordinate conversion for the layer whose display position has been changed. Alternatively, the screen display position control program 202 may change only the display position of display content corresponding to any one of a plurality of layers instead of changing the display position of the overall screen image. In this case, the screen display position control program 202 performs, for example, coordinate conversion for the any layer whose display position has been changed.

The CPU 101 executes the BIOS (Basic Input/Output System) stored in the BIOS ROM 107. The BIOS is a program for hardware control.

The system controller 102 is a bridge device for connecting between a local bus of the CPU 101, each device on a PCI (Peripheral Component Interconnect) bus, and each device on an LPC (Low Pin Count) bus. The system controller 102 also incorporates an IDE (Integrated Drive Electronics) controller for controlling the SSD 109. The system controller 102 also has a function of executing communication with the sound controller 106. The system controller 102 also has a function of executing communication with the GPU 105 via a serial bus complying with the PCI EXPRESS standards.

The GPU 105 is a display controller which controls an LCD 17A used as the display monitor of the tablet computer 10. The video signal (also called the display signal) generated by the GPU 105 is sent to the LCD 17A.

The sound controller 106 is a sound source device. This device outputs audio data to be reproduced to loudspeakers 18A and 18B. The wireless LAN controller 112 is a wireless communication device which executes wireless communication complying with, for example, the IEEE802.11 standards.

The EC 113 is an embedded controller for power management. The EC 113 has a function of powering on/off the tablet computer 10 in accordance with operation by the user. A power supply circuit 121 generates operating power to be supplied to each component of the tablet computer 10 by using the power supplied from a battery 122 in the tablet computer 10 or the power supplied from an external power supply such as an AC adapter 123. The power supply circuit 121 also charges the battery 122 by using the power supplied from an external power supply.

The touch screen display 17 incorporates a touch panel 17B in addition to the LCD 17A. The touch panel 17B is mounted on the LCD 17A (display module) so as to include the LCD 17A. In other words, the touch panel 17B is provided on the LCD 17A (display module). The touch panel 17B includes a sensor and an MCU (Micro Controller Unit). When the user performs touch operation on the touch panel 17B, the sensor detects the touched position. The MCU then outputs input information including the touched position on the touch panel 17B.

The video memory (VRAM) 105A is connected to the graphics controller 105. The video memory (VRAM) 105A stores, for example, screen image data corresponding to a screen image displayed on an external display or the LCD 17A.

The acceleration sensor 205 is a sensor to be used for detecting the motion of the tablet computer 10 (e.g., the shaking or tilting of the main body 1 of the tablet computer 10). This sensor detects a value of an acceleration which changes when the main body 1 of the tablet computer 10 is moved.

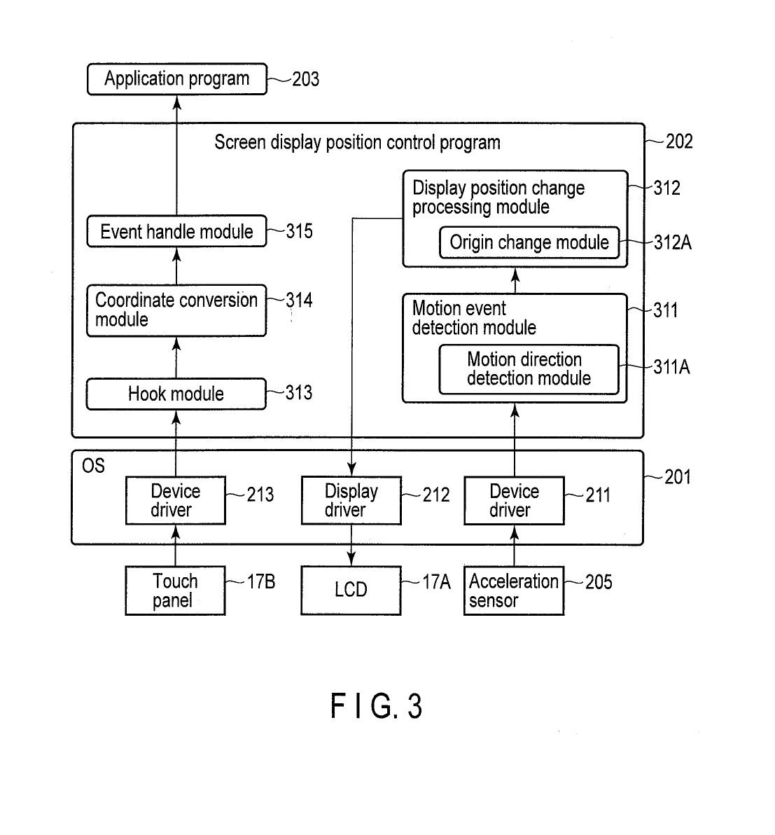

The system configuration of the screen display position control program 202 will be described next with reference to FIG. 3.

The screen display position control program 202 includes a motion event detector 311, a display position change processing module 312, a hook module 313, a coordinate conversion module 314, and an event handle module 315. The motion event detector 311 detects the motion of the tablet computer 10 based on the acceleration (detected value) sent from the acceleration sensor 205 via a device driver 211 in the OS 201. The motion event detector 311 detects the motion of the tablet computer 10 based on whether the acceleration detected by the acceleration sensor 205 exceeds a threshold. The acceleration sensor 205 can detect accelerations in a plurality of axis (the three axes, i.e., the X-axe, Y-axe, and Z-axe) directions, and hence can detect that the tablet computer 10 is moved (e.g., shaken), if an acceleration (detected value) in at least one of the plurality of axis directions exceeds a threshold.

The motion event detector 311 includes a motion direction detector 311A. The motion direction detector 311A detects the motion direction of the tablet computer 10. The motion direction of the tablet computer 10 is the direction in which the tablet computer 10 is moved and the direction of acceleration which can be detected by the acceleration sensor 205. The direction of acceleration which can be detected by the acceleration sensor 205 is, for example, the direction of acceleration generated by displacing the tablet computer 10 in a predetermined direction while changing the velocity of the tablet computer 10. The direction of acceleration which can be detected by the acceleration sensor 205 is, for example, the direction of acceleration generated by rotating the tablet computer 10 in a resting state while changing the velocity of the tablet computer 10.

When the motion event detector 311 detects a motion, the display position change processing module 312 functions as a controller configured to change the display position of the display content displayed on the screen of the LCD 17A by using a display driver 212 in the OS 201. For example, as described above, the display position change processing module 312 changes the display position of the screen image on the screen so as to make part of the screen image run off the screen to be hidden.

The display position change processing module 312 changes the display position of the display content by moving the display position of the display content in a direction associated with the motion direction detected by the motion direction detector 311A. For example, it is assumed the case that the tablet computer 10 is shaken such that the upper portion of the tablet computer 10 is moved toward the near side and the lower portion of the tablet computer 10 is moved toward the far side. In this case, the motion direction detector 311A detects a direction toward the near side as the motion direction of the tablet computer 10. In this case, the display position change processing module 312 moves the display position of the display content downward. For example, the display position change processing module 312 shifts the display position of the screen image downward so as to make a lower peripheral portion of the screen image run off the lower portion of the screen. For example, it is assumed the case that the tablet computer 10 is shaken such that the lower portion of the tablet computer 10 is moved toward the near side and the upper portion of the tablet computer 10 is moved toward the far side. In this case, the motion direction detector 311A detects a direction toward the far side as the motion direction of the tablet computer 10. In this case, the display position change processing module 312 moves the display position of the display content upward. For example, the display position change processing module 312 shifts the display position of the screen image upward so as to make an upper peripheral portion of the screen image run off the upper portion of the screen. For example, it is assumed the case that the tablet computer 10 is shaken such that the right portion of the tablet computer 10 is moved toward the near side and the left portion of the tablet computer 10 is moved toward the far side. In this case, the motion direction detector 311A detects a direction toward the left near side as the motion direction of the tablet computer 10. In this case, the display position change processing module 312 moves the display position of the display content in the leftward direction. For example, the display position change processing module 312 shifts the display position of the screen image in the leftward direction so as to make a left peripheral portion of the screen image run off the left portion of the screen.

Note that the display position change processing module 312 can change the display position of the display content displayed on the screen of the LCD 17A in a predetermined direction regardless of the motion direction detected by the motion direction detector 311A. The display position change processing module 312 can change the display position of the display content if the motion is detected by the motion event detector 311.

In addition, the display position change processing module 312 can change the display position of display content by moving the display position of the display content, wherein the display position of the display content is moved by a distance corresponding to a detected value from the acceleration sensor 205. This can relatively decrease the distance by which the display position is to be moved, when the user slightly shakes the tablet computer 10. And this can increase the distance by which the display position is moved, when the user strongly shakes the tablet computer 10.

Assume that after the display position of display content is moved, the motion event detector 311 detects the motion of the tablet computer 10 again. In this case, the display position change processing module 312 returns the display position of the display content to the display position before the change of the display content. In addition, after the display position of the display content is changed, the display position change processing module 312 can continuously change the coordinates, on the screen, of the display position of the display content. The display position change processing module 312 can continuously change the coordinates so as to return the display position of the display content to the display position before the change of the display content over a predetermined period of time.

The display position change processing module 312 includes an origin change module 312A. The origin change module 312A changes the coordinates of a predetermined origin to change the display position of the display content, wherein the predetermined origin is concerning the display content.

The hook module 313 hooks a position event sent from the touch panel 17B via a device driver 213 in the OS 201. A position event is, for example, an event indicating that touch operation is performed. Upon hooking a position event, the hook module 313 acquires information from the touch panel 17B via the device driver 213, wherein the information is concerning the touch position (coordinates) detected by the touch panel 17B.

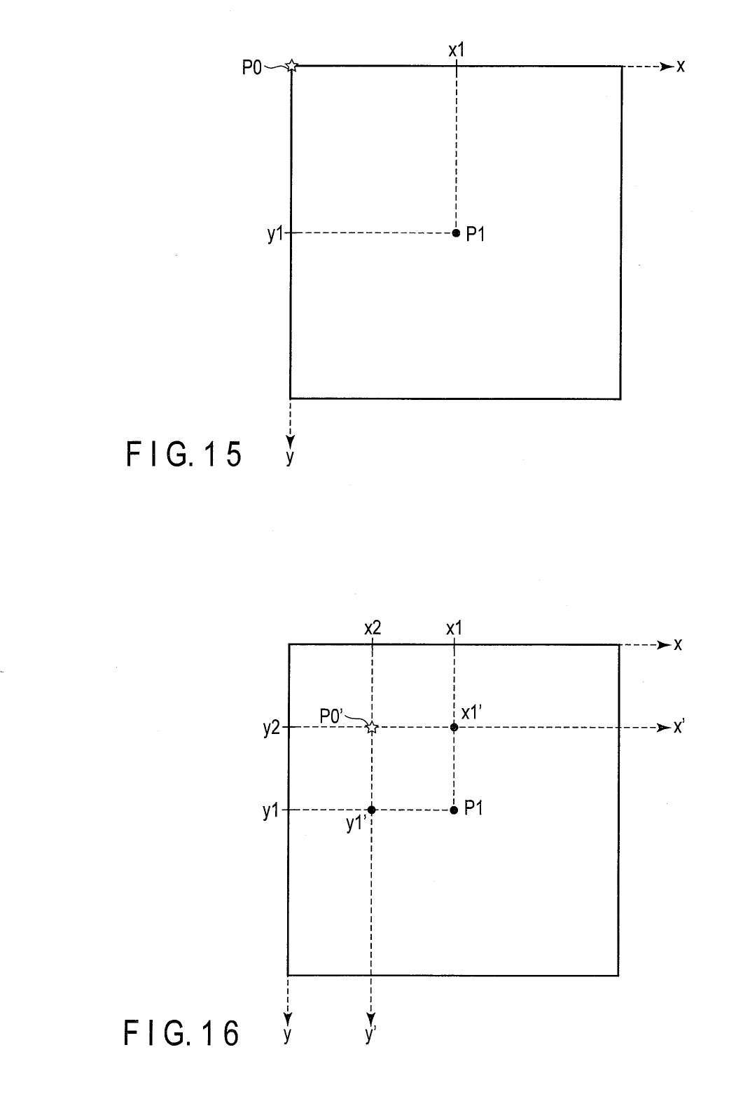

The coordinate conversion module 314 converts the input coordinates (touch panel coordinates) into processing target coordinates (screen coordinates) on the display content. The input coordinates indicate the touch position on the screen. The coordinate conversion module 314 converts the input coordinates into processing target coordinates based on the display position after the change of the display content. The coordinate conversion module 314 converts the input coordinates into processing target coordinates based on the offset value between the display position after the change of the display content and the display position before the change of the display content. This operation will be described in more detail with reference to FIGS. 15 and 16.

The event handle module 315 sends a position event to an application program 203. The application program 203 is the destination of the position event hooked by the hook module 313. In addition, the position event is sent from the event handle module 315 to the application program 203. The position event includes information concerning the screen coordinates, the screen coordinates converted from the input coordinates by the coordinate conversion module 314.

Based on information concerning the screen coordinates sent from the event handle module 315, the application program 203 performs the processing to be performed when the user touches a position on the screen which corresponds to screen coordinates.

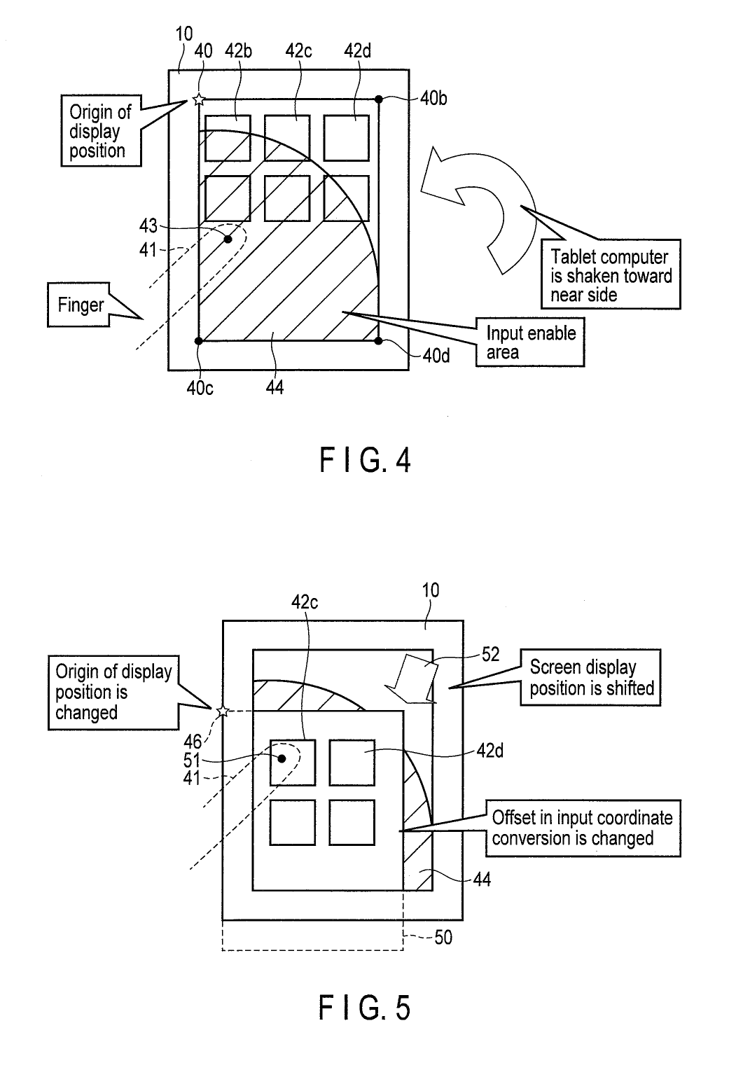

An outline of display position change processing in this embodiment will be described next with reference to FIGS. 4 and 5.

FIG. 4 is a view showing a state (normal display state) before a display position is changed.

A normal display state is a state before the display position of display content drawn by an application program is changed by the screen display position control program 202. In contrast, an offset display state like that shown in FIG. 5 is a state after the display position of display content is changed by the screen display position control program 202.

An origin 40 indicates the origin of the display position of display content in the normal display state. Referring to FIG. 4, the display content is the content displayed in the screen area defined by the origin 40, a symbol 40b, a symbol 40d, and a symbol 40c. This screen area may include objects and the like which can be selected by touch operation. FIG. 4 shows objects as an object 42b, an object 42c, an object 42d, and the like. This screen area may also include operation buttons and the like for changing the display content. The operation buttons include, for example, an address bar in an application such as a browser and a button for switching pages in the browser.

An input enable area 44 (indicated by the hatching in FIG. 4) is an area where the user can perform operation with finger 41 of his/her one hand when he/she operates the tablet computer 10 while holding the tablet computer 10 with the his/her one hand. The area where the user can perform operation with the finger 41 of his/her one hand is an area where the user can easily operate the screen of the tablet computer 10 with the finger 41 of his/her one hand. Note that the area where the user can easily operate is an area where the user can (is estimated to) easily operate the screen of the tablet computer 10 with the finger 41 without changing the holding position of the tablet computer 10 by moving the finger 41. The input enable area 44 is indicated by a sectoral area about ¼ smaller in size than a circle, as shown in, for example, FIG. 4. In such a case, since the input enable area 44 is part of the screen area, for example, the user cannot perform touch operation on the object 42d with a finger of the same hand as that holding the tablet computer 10. In this case, the user can move the display position of the display content downward by, for example, shaking the tablet computer 10 toward the near side. A touch position 43 is the position on the screen which is touched with the finger 41.

The association between the shaking direction of the tablet computer 10 and the direction in which the display position of display content is changed will be described in detail below. The acceleration sensor 205 can detect accelerations corresponding to a plurality of axes, as described above. The screen display position control program 202 can therefore obtain information for the shaking direction of the tablet computer 10 from the direction of acceleration.

For example, the shaking direction of the tablet computer 10 is the direction in which the user shakes the tablet computer 10 toward the finger 41 relative to the screen while holding the tablet computer 10 with his/her left hand, as shown in FIG. 4. In addition, the direction in which the display position of the display content is moved is, for example, the direction in which the display position of the display content approaches the left hand (finger 41) of the user.

More specifically, the user decides in advance a position (holding position) at which the user is supposed to hold the tablet computer 10. The user decides in advance a position at which the user is supposed to easily shake the tablet computer 10 at the holding position while holding the tablet computer 10. For example, it is assumed that the holding position is at the lower left of the tablet computer 10 as shown in FIG. 4. In this case, it is possible to associate in advance the direction in which the user is supposed to be able to easily shake the tablet computer 10 while holding the tablet computer 10 at the holding position and the direction in which the display position of the display content is changed. The direction in which the display position of the display content is changed is the direction denoted by reference numeral 52 in FIG. 5. Note that in this embodiment, a holding position may not be decided.

FIG. 5 is a view showing a state (offset display state) after a display position is changed.

When the user shakes the tablet computer 10, the display position of display content is shifted in the direction denoted by reference numeral 52. Referring to FIG. 5, the display position of the display content is shifted to the position indicated by an area 50. When the display position of the display content is shifted in this manner, the object 42c and the object 42d are included in the input enable area 44. This allows the user to select the object 42c, object 42d, or the like, with the finger 41. The object 42c, object 42d, or the like is located in the area where he/she cannot select any of the objects because the finger 41 cannot reach any of the objects in the normal display state.

The display position of display content is changed by changing the position of the origin of the display position. Referring to FIG. 5, the position of the origin 40 is changed to the position of an origin 46. In addition, offset in input coordinate conversion to be need by changing the display position of the display content will also be changed.

Note that when the user shakes the tablet computer 10, the moving distance of the display position of display content may be changed in accordance with, for example, the strength of shaking, instead of being constant moving distance. For example, by the user shakes the tablet computer 10 strongly, the value detected by the acceleration sensor 205 increases. The origin change module 312A may decide the moving distance of the display position of display content in accordance with the value of the acceleration sensor 205, wherein the moving distance is indicated by the distance between the origin 40 and the origin 46.

Note that when the tablet computer 10 is shaken in the offset display state and the value of the acceleration sensor 205 exceeds a threshold, the offset display state transits to the normal display state. However, it is also possible to transit from the offset display state to the normal display state without shaking the tablet computer 10. For example, after the normal display state transits to the offset display state, the offset display state may gradually transit to the normal display state over a predetermined period of time. More specifically, it is possible to make gradual transition from the offset display state to the normal display state over a predetermined period of time by moving the origin 46 from the position of the origin 46 to the position of the origin 40. The origin 46 corresponds to the area 50 indicating the display position of the display content.

Alternatively, when the normal display state transits to the offset display state, the display position (coordinates) of the display content may be continuously changed over a predetermined period of time. More specifically, the state transits from the normal display state to the offset display state by moving the display position of the display content from the position of the origin 40 to the position of the origin 46 over a predetermined period of time.

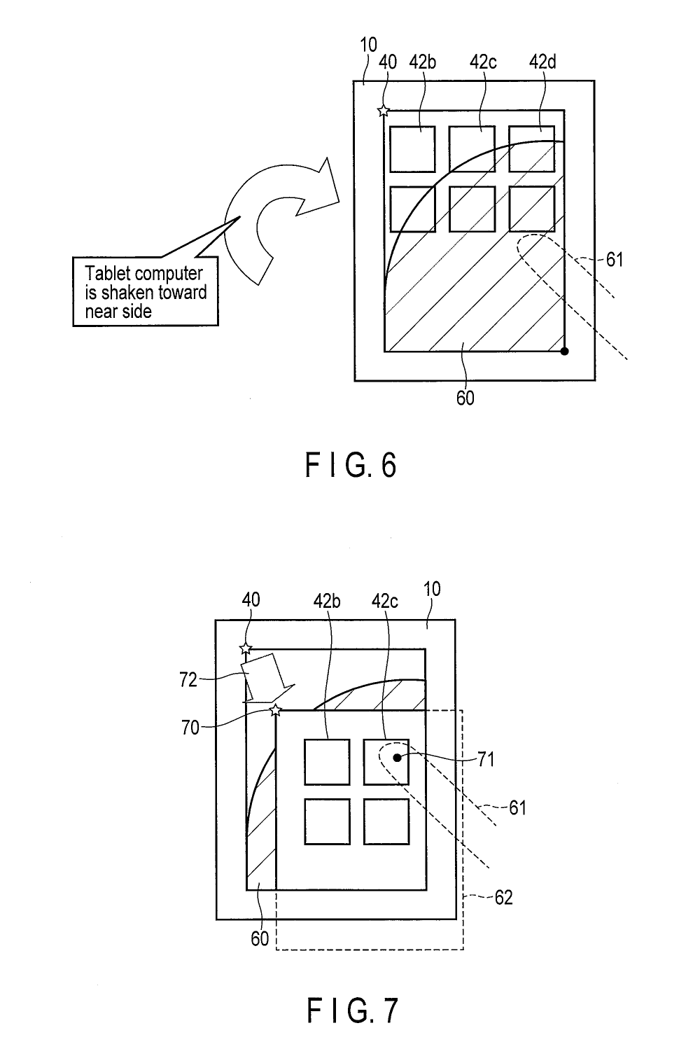

Another example of an offset display screen in this embodiment will be described next with reference to FIGS. 6 and 7.

FIGS. 4 and 5 assume a case in which the user holds the tablet computer 10, for example with his/her left hand. FIGS. 6 and 7 assume that the user holds the tablet computer 10 with his/her right hand. Note that in this embodiment the display position of display content is changed in accordance with the manner of moving, e.g., shaking, the tablet computer 10, regardless of which part of the tablet computer 10 the user holds. Note that a description of the same content as those described with respect to FIGS. 4 and 5 will be omitted in the following description.

An input enable area 60 (indicated by the hatching in FIG. 6) is an area where the user can operate the tablet computer 10 with his/her finger 61 of one hand while holding the tablet computer 10 with his/her hand (e.g., the right hand). The area where the user can perform operation with the finger 61 of one hand is an area where the user can easily operate the screen of the tablet computer 10 with the finger 61 of one hand. Note that the area where the user can easily operate is an area where the user can (is estimated to) easily operate the screen of the tablet computer 10 with the finger 61 without changing the holding position of the tablet computer 10 by moving the hand corresponding to the finger 61. The input enable area 60 is indicated by a sectoral area about ¼ smaller in size than a circle, as shown in, for example, FIG. 6. In such a case, the input enable area 60 is part of the screen area. For example, in the part of the screen area, the user cannot perform touch operation on part of the object 42b or 42c with the finger 61 of the same hand (right hand) as that holding the tablet computer 10. That is, it is difficult for the user to perform touch operation on a screen area other than the input enable area 60.

As in the case shown in FIG. 4, in the case shown in FIG. 6, the tablet computer 10 is shaken in, for example, a direction toward the near side. However, unlike in the case shown in FIG. 4, the tablet computer 10 shown in FIG. 6 is shaken such that the motion (speed) of an upper left portion of the tablet computer 10 changes more largely than motion (speed) of another portion of the tablet computer 10. The upper left portion is, for example, a partial area of the tablet computer 10 which includes the origin 40. The motion (speed) of another portion of the tablet computer 10 is, for example, an upper right, lower right, or lower left portion of the tablet computer 10.

FIG. 7 shows the offset display state in which the display position of the display content is moved in the lower right direction (the direction denoted by reference numeral 72) by a user shaking the tablet computer 10 in, for example, a direction toward the near side as shown in FIG. 6.

The user shakes the tablet computer 10. Upon shaking the tablet computer 10, the display position of the display content shifts in the direction denoted by reference numeral 72. As shown in FIG. 7, the display position of the display content shifts to the position indicated by an area 62. Thus, the input enable area 60 includes the object 42b and object 42c. In the normal display state, the object 42b and a part of the object 42c are located in the area where he/she cannot select them because the finger 61 cannot reach the object 42b and the part of the object 42c. In the offset display state, the object 42b and the part of the object 42c are located in the area he/she can select them.

The display position of display content is changed by changing the position of the origin of the display position. Referring to FIG. 7, the position of the origin 40 is changed to the position of an origin 70. In addition, offset in input coordinate conversion to be needed by changing the display position of the display content will also be changed.

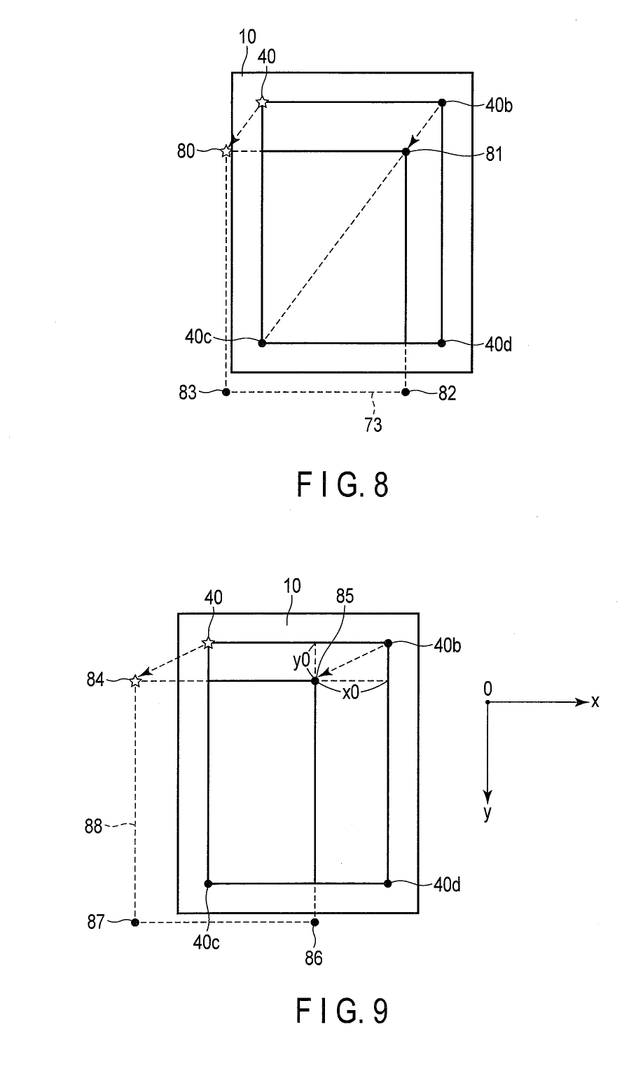

Still another example of an offset display screen will be described next with reference to FIGS. 8, 9, 10, 11, 12, and 13.

Like FIG. 4, FIG. 8 assumes that the user shakes the tablet computer 10 in a direction toward such as the near side. More specifically, the tablet computer 10 shown in FIG. 8 is shaken such that the motion (speed) of an upper right portion of the tablet computer 10 changes more largely than motion (speed) of another portion of the tablet computer 10. The upper right portion of the tablet computer 10 is, for example, a partial area of the tablet computer 10 which includes the symbol 40b. The another portion of the tablet computer 10 is, for example, an upper left, lower left, or lower right portion of the tablet computer 10.

Referring to FIG. 8, by shaking the tablet computer 10 in, for example, a direction toward the near side, the display position of display content will be changed. The display position of display content will be changed so as to locate the display position on a straight line (a diagonal line of the screen) connecting the symbol 40b and the symbol 40c, wherein the display position on a straight line is the display position after the change of the display content. Note that the display position after the change of the display content is indicated by an area 73, the area 73 defined by an origin 80, a symbol 81, a symbol 82, and a symbol 83. To change the display position of the display content to the display position indicated by the area 73, the screen display position control program 202 changes the position of the origin 40. The screen display position control program 202 changes the position of the origin 40 to locate the origin 80 in a direction parallel to a straight line connecting the symbol 40b and the symbol 40c.

Note that the value of acceleration detected by the acceleration sensor 205 will be change by changing the strength (speed) of shaking. The moving distance of the display position of the display content may therefore be changed in accordance with the strength of shaking. More specifically, the screen display position control program 202 may change the distance corresponding to the distance between the symbol 40b and the symbol 81 on a straight line connecting the symbol 40b and the symbol 40c in accordance with the strength of shaking. That is, the screen display position control program 202 may change the distance corresponding to the distance between the origin 40 and the origin 80, in accordance with the strength of shaking.

As described above, referring to FIG. 8, by only shaking the tablet computer 10, the user can always change the display position of display content along a diagonal line of the screen. Note that the above diagonal line of the screen is not limited to a straight line connecting the symbol 40b and the symbol 40c, and may be a straight line connecting the origin 40 and the symbol 40d. Assume that the display position of the display content is changed in the manner as shown in FIG. 8. In this case, it is possible to assume that when the user shakes the tablet computer 10 in a direction toward the near side while holding the tablet computer 10 with his/her left hand, the display position of the display content is changed to approach the hand holding the tablet computer 10.

FIG. 9 assumes that the display position of display content is changed in accordance with the magnitude of a component in the shaking direction (the strength of shaking) of the tablet computer 10. The x-y coordinates shown on the right side of FIG. 9 indicate screen coordinates. FIG. 9 shows the offset display state in which the x direction component of the strength of shaking is larger than the y direction component of the strength of shaking.

For the sake of descriptive convenience, a shaking direction is associated with a corresponding direction on screen coordinates in FIGS. 9, 10, and 11. That is, in practice, a shaking direction is the direction of acceleration detected by the acceleration sensor 205, and is sometimes different from a corresponding direction on screen coordinates.

Referring to FIGS. 9, 10, and 11, the x-direction component of the strength of shaking is a component of the strength of shaking in a case in which the magnitude (speed) of shaking on the right side of the tablet computer 10 is larger than the magnitude (speed) of shaking on the left side of the tablet computer 10. The right side of the tablet computer 10 is the side close to a straight line connecting the symbol 40b and the symbol 40d in FIG. 9. The left side of the tablet computer 10 is the side close to a straight line connecting the origin 40 and the symbol 40c in FIG. 9.

Referring to FIGS. 9, 10, and 11, the y-direction component of the strength of shaking is a component of the strength of shaking in a case in which the magnitude (speed) of shaking on the upper side of the tablet computer 10 is larger than the magnitude (speed) of shaking on the lower side of the tablet computer 10. The upper side of the tablet computer 10 is the side close to a straight line connecting the origin 40 and the symbol 40b in FIG. 9. The lower side of the tablet computer 10 is the side close to a straight line connecting the symbol 40c and the symbol 40d in FIG. 9.

Referring to FIG. 9, it is assumed the case that the tablet computer 10 is shaken so as to make the x direction component of the strength of shaking larger than the y component of the strength of shaking. In this case, the position of the symbol 40b is changed to the position of a symbol 85. The position of a symbol 85 is the position that the position of the symbol 40b is moved by x0 (>y0) in the negative direction of the x-axis of the screen coordinates and by y0 (<x0) in the positive direction of the y-axis of the screen coordinates. In this manner, it is possible to change x0 indicating the x component in the moving direction of the display position of the display content in proportion to the magnitude of the x direction component of the strength of shaking. On the other hand, it is possible to change y0 indicating the y component in the moving direction of the display position of the display content in proportion to the magnitude of the y direction component of the strength of shaking.

To change the position of the symbol 40b to the position of the symbol 85, the screen display position control program 202 changes the position of the origin 40 to the position of an origin 84. The position of an origin 84 is the position that the position of the origin 40 is moved by x0 in the negative direction of the x-axis and by y0 in the positive direction of the y-axis. This changes the display position of the display content to the position indicated by an area 88, the area 88 defined by the origin 84, the symbol 85, a symbol 86, and a symbol 87.

As shown in FIG. 9, by changing the display position of the display content in accordance with the magnitude of a component in the direction of shaking the tablet computer 10, for example, the user can change the display position of the display content to a desired display position.

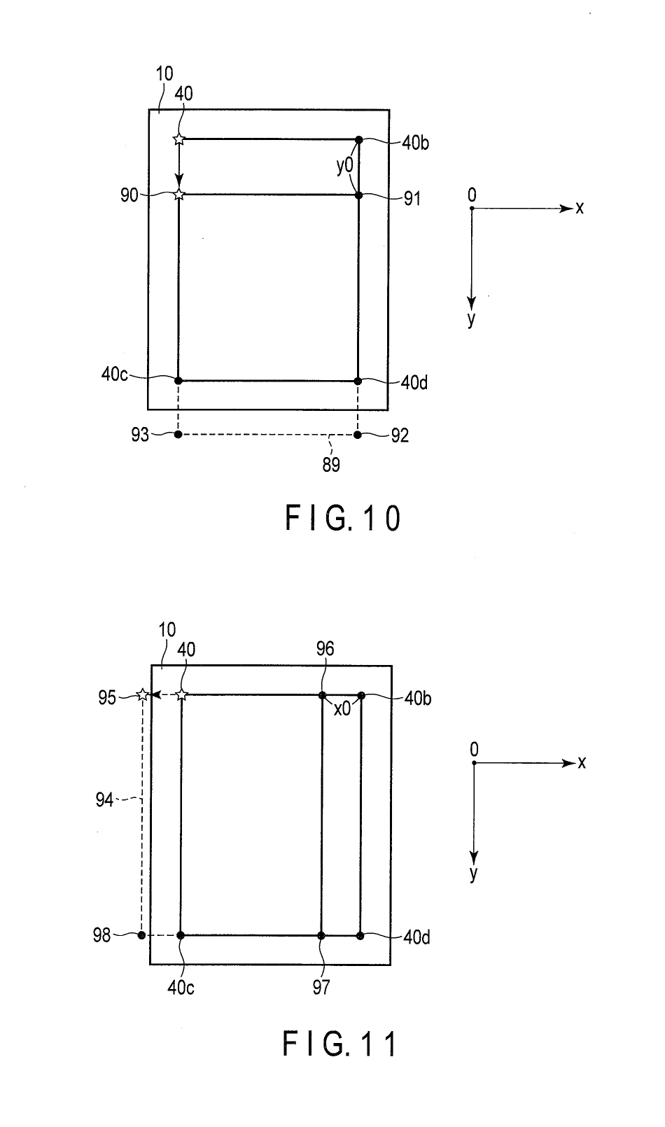

Another example of the offset display screen will be described next with reference to FIGS. 10 and 11. Note that a description of the same content as those described with reference to FIG. 9 will be omitted.

FIG. 10 assumes a case in which the display position of the display content is changed in accordance with the magnitudes of the x direction and y direction components of the strength of shaking, as described with reference to FIG. 9. FIG. 10 shows an offset display state when there is not x direction component of the strength of shaking. More specifically, by shaking the tablet computer 10 in, for example, a direction toward the near side without any x direction component of the strength of shaking (for example, the magnitude of an x direction component is 0), the position of the symbol 40b will be changed to the position of a symbol 91 by y0. The screen display position control program 202 changes the position of the origin 40 to the position of a symbol 90, wherein the position of a symbol 90 is the position that the position of the origin 40 is moved by y0 in the positive direction of the y-axis. In addition, the display position of the display content after the change is indicated by an area 89, the area 89 defined by an origin 90, the symbol 91, a symbol 92, and a symbol 93.

Referring to FIG. 10, by shaking the tablet computer 10 in, for example, a direction toward the near side, the display position of the display content can be changed in the positive or negative direction of the y axis regardless of the magnitude of the x direction component of the strength of shaking. For example, the value of y0 may be changed in accordance with only the magnitude of the y direction component of the strength of shaking. In addition, referring to FIG. 10, the display position of the display content may be changed by shaking the tablet computer 10 in, for example, a direction toward the near side with y0 being a constant value regardless of the strength of shaking. Alternatively, setting may be made in advance to regard that there is not x direction component of the strength of shaking when the magnitude of the x direction component of the strength of shaking does not exceed a predetermined value. Referring to FIG. 10, the display position of the display content may be changed to a position like that shown in FIG. 10 by shaking the tablet computer 10 in, for example, the vertical direction (y-axis direction) instead of shaking the tablet computer 10 in a direction toward the near side. Note that y0 in FIG. 10 need not be equal to the value of y0 in FIG. 9.

FIG. 11 assumes a case in which the display position of the display content to be changed is changed in accordance with the magnitudes of the x direction and y direction components of the strength of shaking as described with reference to FIG. 9, as in the case of FIG. 10. In such a case, FIG. 11 shows an offset display state in which there is not y direction component of the strength of shaking. More specifically, by shaking the tablet computer 10 in, for example, a direction toward the left near side without any y direction component of the strength of shaking (for example, the magnitude of an y direction component is 0), the position of the symbol 40b will be changed to the position of a symbol 96 by x0. The screen display position control program 202 changes the position of the origin 40 to the position of a symbol 95 by moving the position of the origin 40 by x0 in the negative direction of the x-axis. In addition, the display position of the display content after the change is indicated by an area 94, the area 94 defined by an origin 95, the symbol 96, a symbol 97, and a symbol 98.

Referring to FIG. 11, by shaking the tablet computer 10 in, for example, a direction toward the left near side, the display position of the display content can be changed in the negative or positive direction of the x axis regardless of the magnitude of the y direction component of the strength of shaking. For example, the value of x0 may be changed in accordance with only the magnitude of the x direction component of the strength of shaking. In addition, referring to FIG. 11, the display position of the display content may be changed by shaking the tablet computer 10 in, for example, the left front direction by x0 being a constant value regardless of the strength of shaking. Alternatively, setting may be made in advance to regard that there is not y direction component of the strength of shaking when the magnitude of the y direction component of the strength of shaking does not exceed a predetermined value. Referring to FIG. 11, the display position of the display content may be changed to a position like that shown in FIG. 11 by shaking the tablet computer 10 in, for example, the lateral direction (x axis direction) instead of shaking the tablet computer 10 in a direction toward the left near side. Note that the value of x0 in FIG. 11 need not be equal to the value of x0 in FIG. 9.

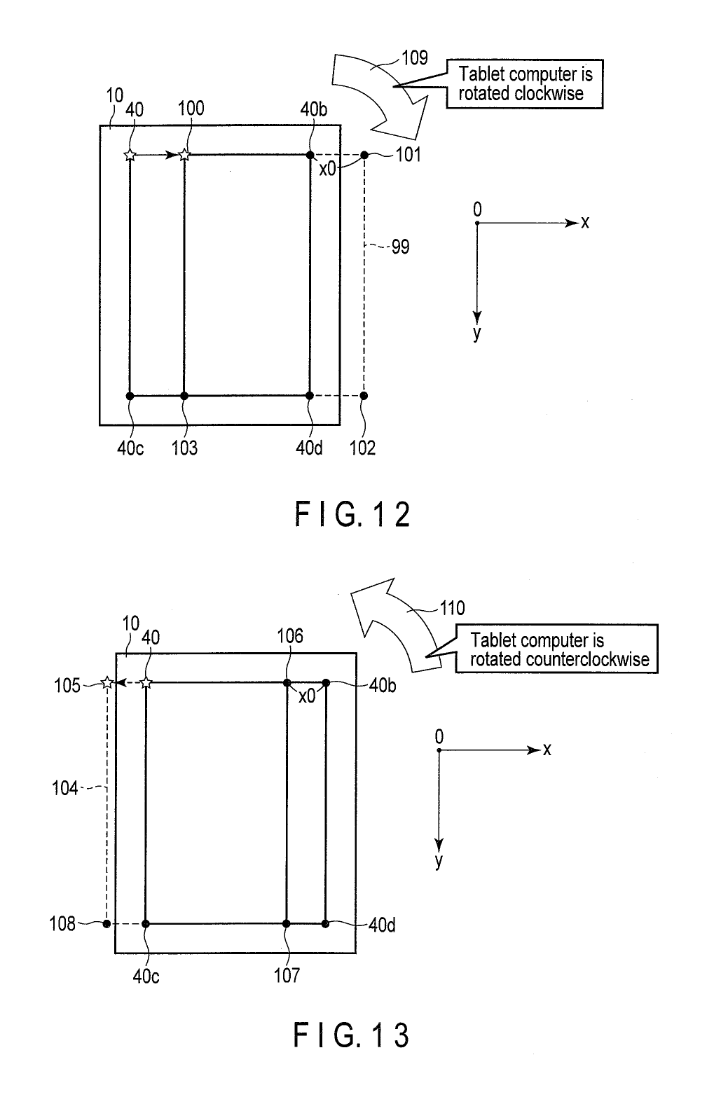

Still another example of the offset display screen will be described next with reference to FIGS. 12 and 13.

Referring to FIG. 12, by rotating (tilting) the tablet computer 10, the display position of display content will be changed. FIG. 12 assumes a case in which the tablet computer 10 be rotated (be tilted) in the clockwise direction. The clockwise direction is the direction indicated by a symbol 109 on the x-y coordinate plane of the screen coordinates. The acceleration sensor 205 can detect the value of acceleration for a rotation with an acceleration instead of a constant velocity even for a rotation indicated by the symbol 109.

More specifically, when the tablet computer 10 be rotated (tilted) in the clockwise direction, the position of the symbol 40b will be changed to the position of a symbol 101, wherein the position of a symbol 101 is the position that the position of the symbol 40b is moved by x0 in the positive direction of the x axis. The screen display position control program 202 changes the position of the origin 40 to the position of an origin 100, wherein the position of an origin 100 is the position that the position of the origin 40 is moved by x0 in the positive direction of the x-axis. Note that the display position of the display content is changed to the position indicated by an area 99, the area 99 defined by the origin 100, the symbol 101, a symbol 102, and a symbol 103.

Referring to FIG. 13, as in the case of FIG. 12, the display position of the display content is changed by rotating (tilting) the tablet computer 10. FIG. 13 assumes a case in which the tablet computer 10 be rotated (be tilted) in the counterclockwise direction. The counterclockwise direction is the direction indicated by a symbol 110 on the x-y coordinate plane of the screen coordinates.

More specifically, when rotating (tilting) the tablet computer 10 in the counterclockwise direction, the position of the symbol 40b will be changed to the position of a symbol 106, wherein the position of a symbol 106 is the position that the position of the symbol 40b is moved by x0 in the negative direction of the x axis. The screen display position control program 202 changes the position of the origin 40 to the position of an origin 105, wherein the position of an origin 105 is the position that the position of the origin 40 is moved by x0 in the negative direction of the x-axis. Note that the display position of the display content is changed to the position indicated by an area 104, the area 104 defined by the origin 105, the symbol 106, a symbol 107, and a symbol 108. Note that the value of x0 in FIG. 13 need not be equal to the value of x0 in FIGS. 9, 11, and 12.

Instead of rotating the tablet computer 10 in any one of the clockwise direction or the counterclockwise direction as shown in FIGS. 12 and 13, the tablet computer 10 may be alternately rotated in the clockwise direction and the counterclockwise direction. Also, in this case, it is possible to change the display position of the display content in the positive direction of the x-axis as shown in FIG. 12, or in the negative direction of the x-axis as shown in FIG. 13.

As described above, by combining examples of changing the screen display position as shown in FIGS. 8, 9, 10, 11, 12, and 13, the display position of the display content can be changed to different display positions in accordance with each of a plurality of different types of manner of moving (shaking) the tablet computer 10. By combining examples of changing the screen display position as shown in FIGS. 8, 9, 10, 11, 12, and 13, the display position of the display content can be changed to different display positions in accordance with each of a plurality of different motion directions (shaking directions) of the tablet computer 10.

With regard to the position of an origin, as shown in FIGS. 4, 5, 6, 7, 8, 9, 10, 11, 12, and 13, although the origin may be located at an upper left end of the screen, the origin may be located at an upper right end point (40b or the like) of the screen, a lower right position (40d or the like) of the screen, or a lower left position (40c or the like) of the screen.

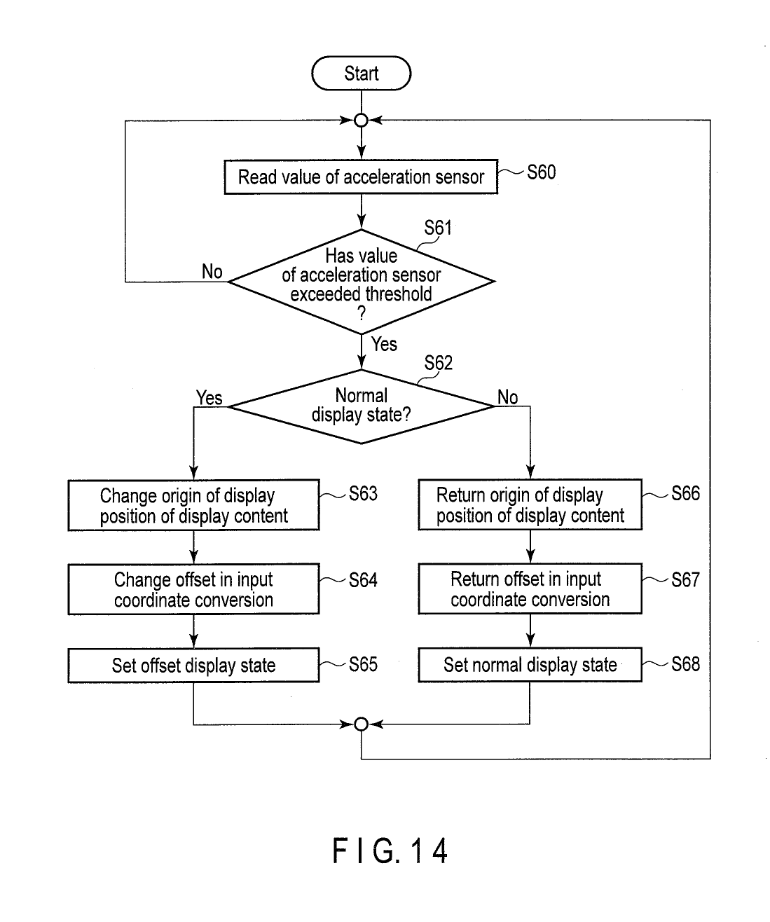

A processing procedure for screen display position control will be described next with reference to the flowchart of FIG. 14.

In a state in which the acceleration sensor 205 is detecting the acceleration, the acceleration produced when the tablet computer 10 moves, the screen display position control program 202 reads (detects) the value of the acceleration sensor 205 (step S60). The screen display position control program 202 determines whether the value (detected value) of the acceleration sensor 205 exceeds a predetermined threshold (step S61). If the value of the acceleration sensor 205 does not exceed the threshold (NO in step S61), the process returns to step S60. If the value of the acceleration sensor 205 exceeds the threshold (YES in step S61), the screen display position control program 202 checks the display state of the tablet computer 10 (step S62). If the display state of the tablet computer 10 is the normal display state (YES in step S62), the process advances to step S63. If the display state of the tablet computer 10 is not the normal display state (NO in step S62), the process advances to step S66.

In step S63, the screen display position control program 202 changes the origin of the display position of the display content toward the hand of the user who holds the tablet computer 10 in the normal display state. It is assumed the case that for example the upper left vertex of the screen is set as an origin, the rightward direction of the screen is set as the positive x direction, and the downward direction of the screen is set as the positive y direction. In this case, the screen display position control program 202 sets, for example, (ORGx, ORGy) to (−100, 100) (changes the origin to (−100, +100)). The screen display position control program 202 changes the offset in conversion (input coordinate conversion) from the input coordinates to screen coordinates in synchronism with the change of the display position of the display content (step S64). If, for example, the origin (ORGx, ORGy) is converted into (−100, 100), the screen display position control program 202 sets an offset (OFFx, OFFy) to (+100, −100). With this operation, if the input coordinates detected by the touch panel 17B are (x1, y1), input coordinates (x1′, y1′) to be processed are set to (x1, y1)+(OFFx, OFFy). If the actually input coordinates are (+10, +200) when the origin of the display position is changed to (−100, +100), the screen display position control program 202 processes the coordinates as if (+110, +100) were input.

The screen display position control program 202 then changes the current display state of the tablet computer 10 to the offset display state (step S65).

If the display state of the tablet computer 10 is not the normal display state (NO in step S62), the screen display position control program 202 regards that the tablet computer 10 is in the offset display state. And the screen display position control program 202 returns the origin of the display position of the display content to the origin of the display position of the display content in the state before the offset display state is set, e.g., the initial state (step S66). It is assumed the case that for example the upper left position of the screen is set as an origin, and the rightward direction of the screen is set as the positive x direction, and the downward direction of the screen is set as the positive y direction. In this case, the screen display position control program 202 sets, for example, (ORGx, ORGy) to (0, 0) (changes the origin to (0, 0)). The screen display position control program 202 returns the offset in conversion, wherein the offset in conversion is that in conversion from the input coordinates to screen coordinates, to the offset before the change of the display position of the display content in synchronism with the change of the display position of the display content (step S67). If, for example, the origin (ORGx, ORGy) is changed to (0, 0), the screen display position control program 202 sets the offset (OFFx, OFFy) to (0, 0). With this operation, if the input coordinates detected by the touch panel are (x2, y2), input coordinates (x2′, y2′) to be processed are set to (x2, y2)+(OFFx, OFFy). If the actually input coordinates are (+10, +200) when the origin of the display position is changed to (0, 0), the screen display position control program 202 processes the coordinates as if (+10, +200) were input. The screen display position control program 202 then changes the display state of the tablet computer 10 to the normal display state (step S68).

The change of an offset in input coordinate conversion will be described in detail next with reference to FIGS. 15 and 16.

FIG. 15 shows the coordinate system (screen coordinates) of the screen. An origin P0 indicates the origin (the origin of the screen image) of the screen coordinates. On the x-y coordinates with the origin P0, the rightward direction in FIGS. 15 and 16 is the positive x direction, and the downward direction in FIGS. 15 and 16 is the positive y direction. Arbitrary coordinates P1(x1, y1) on the screen for such screen coordinates will be described.

FIG. 16 shows an input coordinate system (input coordinate) after the display position of the screen image (display content) is changed. An origin P0′ indicates the origin of the input coordinates. In addition, the origin P0′ indicates the coordinates obtained after the origin P0 is moved by (+x2, +y2). On the input coordinates of the x′-y′ coordinate system, the rightward direction in FIG. 16 is the positive x′ direction, and the downward direction in FIG. 16 is the positive y′ direction.

The coordinates (x1, y1) of P1 on the screen coordinates correspond to the input coordinates (x1′, y1′), and (x1, y1) are represented as (x1′, y1′)+(−x2, −y2). That is, to change the coordinates (ORGx, ORGy) of the origin P0 of the display position of the display content by (+x2, +y2) is to change the offset value (OFFx, OFFy) by (−x2, −y2). Therefore, (x1, y1)+(x1′, y1′)+(OFFx, OFFy) holds.

For example, in case of changing the coordinates (ORGx, ORGy) of the origin P0 from (0, 0) to (−100, +100), the offset value (OFFx, OFFy) will be set to (+100, −100). If the input coordinates of P1 are (+10, +200), the screen coordinates (x1, y1) of P1 represent as (+10, +200)+(+100, −100).

In the embodiment described above, when the tablet computer 10 is shaken, the screen display position control program 202 changes the display position of display content. In this case, the screen display position control program 202 may change the display position of display content in accordance with the position on the screen, which is designated by the finger 41 or the like. For example, the designated position on the screen is the touch position 43 pressed with the finger 41 as shown in FIG. 4. Referring to FIG. 4, the screen display position control program 202 may change the display position of the display content such that one of the positions on the screen, one of the positions on the screen being closest to the touch position 43, approaches the touch position 43. One of the positions on the screen is one of the positions that are represented by the origin 40, the symbol 40b, the symbol 40c, and the symbol 40d.

In addition, in the embodiment described above, the sensor for detecting the motion (displacement) of the tablet computer 10 is not limited to the acceleration sensor 205. For example, it is possible to use a gyro scope (gyro sensor). The gyro scope can detect a change of the tilt of the tablet computer 10, i.e., can detect the angular acceleration (rotational motion). If, for example, a change of the tilt of the tablet computer 10 which is detected by the gyro scope exceeds a predetermined threshold, it may be regarded that the motion of the tablet computer 10 is detected.

As described above, according to this embodiment, when the motion of the tablet computer 10 including the touch screen display is detected, it is possible to change the display position of display content displayed on the touch screen display. This improves the operability of the tablet computer 10. Assume that the user holds the tablet computer 10 with his/her hand, and there is an area on the screen which any fingers cannot reach. Even in this case, display content which the user wants to operate can be displayed on the near side by the simple operation of shaking the tablet computer 10 without performing operation with the other hand or switching the tablet computer 10 to the other hand. In addition, since the user changes the display position of display content by shaking the tablet computer 10 instead of touching the screen with his/her finger by touch operation or the like, it is possible to prevent an operation error or the like due to touch operation. Furthermore, by using a sensor like the acceleration sensor 205 which can detect the motion of the tablet computer 10 in a plurality of directions, the detected motion direction can be associated with the direction on the screen in which the display position of the display content is changed. Moreover, since the offset in coordinate conversion from input coordinates to screen coordinates is changed when the display position of display content is changed, the user can select a desired object or operation button without being conscious of input coordinate conversion processing.

All of the sequences of the processes described in this embodiment can be implemented by software. For this reason, by installing a computer program required to implement the sequence of the processes in a normal computer via a computer readable storage medium that stores the program, and executing the installed program, the same effects as those in this embodiment can be easily realized.

In addition, the function of each module shown in FIG. 3 may be implemented by hardware such as a dedicated LSI and DSP.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display;
a touch panel on the display;
a detector configured to detect motion of the electronic apparatus; and
a controller configured to change a display position of an image displayed on the display when the motion is detected.

2. The apparatus of claim 1,
wherein the detector is further configured to detect motion of the electronic apparatus and a direction of the motion, and
wherein the controller is further configured to change the display position of the image based on the direction of the motion.

3. The apparatus of claim 1, wherein the controller is further configured to shift the image in a predetermined direction.

4. The apparatus of claim 1, wherein the controller is further configured to change the display position of the image to a first display position at which part of the image is not displayed on a screen of the display, without changing a size of the image displayed on the screen of the display.

5. The apparatus of claim 1,
wherein the detector is further configured to detect motion of the electronic apparatus, based on a sensor in the electronic apparatus, and
wherein the controller is further configured to move the display position of the image by a distance corresponding to a detection value of the sensor to change the display position of the image.

6. The apparatus of claim 1, wherein the controller is further configured to return the display position of the image to an original display position of the image, when motion of the electronic apparatus is detected after the changing of the display position of the image.

7. The apparatus of claim 1, wherein the controller is further configured to continuously change coordinates of the display position of the image over a predetermined period of time.

8. The apparatus of claim 1, wherein after the display position of the image is changed, the controller continuously changes coordinates of the display position of the image so as to return the display position of the image to an original display position over a predetermined period of time.

9. The apparatus of claim 1, further comprising a convertor configured to convert an input coordinate indicative of a touch position on the touch panel into a target coordinate on the image, based on a first display position after change of the display position of the image.

10. The apparatus of claim 1, further comprising a convertor configured to convert an input coordinate indicative of a touch position on the touch panel into a target coordinate on the image, based on an offset value between a first display position after change of the display position of the image and an original display position of the image.

11. The apparatus of claim 1, wherein the detector is further configured to detect motion of the electronic apparatus by using an acceleration sensor in the electronic apparatus.

12. A display control method comprising:
detecting motion of an electronic apparatus comprising a display and a touch panel on the display; and
changing a display position of an image displayed on the display when the motion is detected.

13. A computer-readable, non-transitory storage medium comprising a computer program configured to be executed by a computer, the computer comprising a display and a touch panel on the display, the computer program controlling the computer to execute functions of:
detecting motion of the computer, and
changing a display position of an image displayed on the display when the motion is detected.
